(19) United States
(12) Patent Application Publication
(10) Pub. No.: US 2009/0099941 A1
(43) Pub. Date: Apr. 16, 2009

(54) SYSTEM AND METHOD FOR ENABLING CASH GIFTS IN AN ONLINE REGISTRY

(76) Inventor: Oded BERKOWITZ, Fort Lee, NJ (US)

Correspondence Address: BLANK ROME LLP, WATERGATE, 600 NEW HAMPSHIRE AVENUE, N.W., WASHINGTON, DC, 20037, US

(21) Appl. No.: 12/253,439

(22) Filed: Oct. 17, 2008

Related U.S. Application Data
(63) Continuation-in-part of application No. 11/924,255, filed on Oct. 25, 2007.
(60) Provisional application No. 60/884,784, filed on Jan. 12, 2007.

(51) Int. Cl. G06Q 20/00; G06Q 30/00; G06Q 10/00

(52) U.S. Cl. 705/26; 705/40; 705/34

(57) ABSTRACT

A system and method for facilitating cash gifts by enabling a gift recipient to create an online gift registry which includes an option to allow gift givers to make cash gifts in addition to traditional consumer goods from multiple merchants. Other applications of the system and method include, but are not limited to, allowing gift givers to contribute cash toward the purchase of an expensive item and an automated system for sending thank you cards to gift givers from gift recipients.

The present application is a continuation-in-part of U.S. patent application Ser. No. 11/924,255, filed Oct. 25, 2007, currently pending, which claims the benefit of U.S. Provisional Patent Application No. 60/884,784, filed Jan. 12, 2007. The disclosures of those applications are hereby incorporated by reference in their entirety into the present application.

### BACKGROUND OF THE INVENTION

1. Field of Invention

The invention is related to the field of electronic commerce using the Internet and, more particularly, to a system and method for enabling cash gifts in an online gift registry.

2. Description of Related Art

To facilitate gift giving at special occasions, many Internet websites allow gift recipients to set up an online gift registry. Systems in which the registry holder, or gift recipient, can set up his or her own gift registry and select gifts that he or she would like gift givers to purchase on his or her behalf are known in the art. Gift givers, upon visiting the recipient's gift registry website, can select which gift or gifts to purchase for the recipient. Some such gift registry systems also allow a gift giver to contribute a certain amount toward the purchase of an expensive item. In this way, the gift recipient can avoid receiving gifts that he or she does not want. Online gift registry systems currently exist which allow gift recipients to select gifts from one merchant or multiple merchants to be purchased on their behalf by gift givers.

It is recognized that gift recipients would prefer, in many instances, to simply receive cash instead of material gifts, but for many years requesting cash has been seen as socially unacceptable. The benefits of receiving a cash gift include the ability to make a purchase at a later time, flexibility for the gift recipient to apply the cash to expenditures as he or she sees fit, flexibility for the gift giver to spend the exact amount desired, and the ability for the gift recipient to receive cash gifts to be applied toward more expensive, big ticket items such as trips, a car, or a down payment on a home. Most gift recipients, however, do not directly ask for cash gifts from gift givers for any of a number of reasons including difficulty in keeping track of cash gifts received and, as noted above, the apprehension that requesting cash gifts is socially inappropriate.

Systems in which a contribution can be made toward to purchase of particular item are known in the art. U.S. Pat. No. 7,013,292 to Hsu et al., for example, describes a system and method for collecting cash to be applied toward the purchase of a particular gift from several cash gift givers. When the system has received the threshold amount of funds directed toward the purchase of a particular gift, the system places the purchase order for or on behalf of the registry owner. The system sends the gifted money directly to the gift registry owner if the amount gifted toward a particular product is less than the purchase amount needed for that product.

What the prior art systems and methods fail to address, among other things, is the convenience realized by the gift recipient and the gift giver in having the ability to make a cash gift using an online gift registry. The prior art systems and methods can be overly restrictive, in view of the fact that many gift recipients would like more flexibility in how they may apply the funds they have received as cash gifts toward future purchases and expenditures. Systems and methods that focus on simplifying the process and increasing the flexibility afforded to online gift registry users in making cash and receiving cash gifts, would be highly desirable. And until the advent of the present invention, the long felt need of gift registry recipients to have a socially acceptable means to request and receive cash gifts has heretofore been unavailable.

### SUMMARY AND OBJECTS OF THE INVENTION

It should be apparent that there exists a need for a system and method for providing an online gift registry with a cash gift feature that provides desired flexibility for the gift recipient and the gift giver. Accordingly, embodiments of the present invention provide a manner for facilitating cash gifts by enabling a gift recipient to create an online gift registry which includes an option to allow gift givers to make cash gifts in addition to the traditional system of selecting gifts from multiple merchants for purchase by gift givers on the recipient's behalf.

Accordingly, a principal object of the present invention is to provide a manner for facilitating cash gifts by enabling a gift recipient to create an online gift registry which includes an option to allow gift givers to make cash gifts in addition to the traditional system of selecting gifts from multiple merchants for purchase by gift givers on the recipient's behalf.

It is another object of the invention to provide a system and method for providing an online gift registry, wherein during signing up to use the online gift registry system or afterwards, in addition to selecting gifts to be purchased by gift givers on his behalf, a gift recipient is given the option of registering for a cash gift service to allow gift givers to make cash gifts. When a gift giver visits the gift recipient's online gift registry, the gift giver may make a cash gift or choose to purchase for the gift recipient any of the products selected by the recipient. The system allows a gift recipient who elected not to register for the cash gift service to register at a later time should he reconsider.

It is still another object of the invention to provide a system and method for providing a computerized intermediary between gift recipients who wish to receive cash gifts instead of material gifts but who believe that directly requesting cash gifts is socially unacceptable.

It is another object of the invention to provide a system and method for generating income based on referring gift recipients to financial institutions who then establish cash receivable accounts to receive cash gifts given to the gift recipients through an online gift registry. Income may be based on, for example, a percentage or flat fee received from the gift giver when making a cash gift, a percentage or flat fee received from a gift recipient when creating a cash gift account, or a percentage or flat fee received from a third party cash account provider when a third party cash account is created by a user of the online cash gift feature.

It is still another object of the invention to provide a system and method for providing a reloadable debit card linked to a cash account having a gift recipient as the beneficiary in which the cash value of the debit card is adjusted based on cash gifts made to the gift recipient using an online gift registry.

It is another object of the invention to provide a system and method for coordinating the transfer of cash between a gift giver and a gift recipient using an online gift registry in which the gift recipient has established a user profile on a server having a web server that provides instructions to generate web pages on the gift giver's computer, where the transfer of cash may be accomplished by processing a credit card electronic fund transfer (FFT), using a service provider that facilitates transfer of cash gifts directly to a gift recipient's bank account, or other methods.

The above objects and features of the present invention are accomplished, as embodied and fully described herein, by a method for coordinating a financial transaction between a gift giver and a gift registry registrant at an online gift registry comprising the steps of receiving, at a first server over a communications network, a set of registry account information about a gift registry registrant, wherein at least a part of the set of registry account information includes an instruction for depositing cash in at least one cash account; associating the online gift registry account with the at least one cash account; receiving a selection of items to be associated with the online gift registry account, wherein each of the products is selectable for purchase and wherein one of the products is cash; outputting a first instruction to display the selection of items on one or more client computers; receiving a request to process a cash gift amount; initiating a financial transaction to electronically transfer the cash gift amount to the at least one cash gift account; and outputting a second instruction to display information about the transfer.

With those and other objects, advantages and features of the invention that may become hereinafter apparent, the nature of the invention may be more clearly understood by reference to the following detailed description of the invention, the appended claims and to the several drawings attached herein.

### BRIEF DESCRIPTION OF THE DRAWINGS

FIG. 1 is a drawing depicting a schematic of the general system architecture of an online cash gift registry system according to one aspect of the present invention;

FIG. 2 is another drawing depicting a schematic of the general system architecture of an online cash gift registry system according to one aspect of the present invention;

FIG. 3 is another drawing depicting a schematic of the general system architecture of an online cash gift registry system according to one aspect of the present invention;

FIG. 4 is drawing of an exemplary computer screen representation according to one aspect of the present invention;

FIG. 5 is another drawing of an exemplary computer screen representation of one aspect of the present invention;

FIG. 6 is another drawing of an exemplary computer screen representation of one aspect of the present invention;

FIG. 7 is another drawing of an exemplary computer screen representation of one aspect of the present invention;

FIG. 8 is another drawing of an exemplary computer screen representation of one aspect of the present invention;

FIG. 9 is a drawing of an exemplary computer screen representation of an interface module of one aspect of the present invention;

FIG. 10 is a process flow diagram depicting the general user process flow of an online gift registry according to an embodiment of the present invention;

FIG. 11 is another process flow diagram depicting the set up of an online gift registry according to an embodiment of the present invention;

FIG. 11-A is another process flow diagram depicting the set up of an online gift registry including an option cash gift item according to an embodiment of the present invention;

FIG. 12 is a process flow diagram depicting the gift giving process flow according to an embodiment of the present invention; and

FIG. 13 is a process flow diagram depicting the process of giving a cash gift according to an embodiment of the present invention.

FIG. 14 is a process flow diagram depicting the process flow for creating an online gift registry with cash gift feature according to an embodiment of the present invention.

FIG. 15 is a process flow diagram depicting the process flow for creating an online gift registry with cash gift feature according to an embodiment of the present invention.

### DETAILED DESCRIPTION OF THE PREFERRED EMBODIMENT

Several preferred embodiments of the invention are described for illustrative purposes, it being understood that the invention may be embodied in other forms not specifically shown in the drawings.

In the embodiments of the present invention described below the computing platforms perform various functions and operations in accordance with the invention. The computing platforms can be, for instance, a personal computer (PC), server or mainframe computer. The computing platforms can be a general purpose computer reconfigured by a computer program, or may be specially constructed to implement the features and operations of the system. The computing platform may also be provided with one or more of a wide variety of components or subsystems including, for example, a processor, co-processor, register, data processing devices and subsystems, wired or wireless communication links, input devices, monitors, memo or storage devices such as a database. The computing platform can be available only to one or more individuals, or publicly available such as in the form of a kiosk.

The system can be a network configuration or a variety of data communication network environments using software, hardware or a combination of hardware and software to provide the processing functions. All or parts of the system and processes can be stored on or read from computer-readable media. The system can include computer-readable medium having stored thereon machine executable instructions for performing the processes described. Computer readable media may include, for instance, secondary storage devices, such as hard disks, floppy disks, and CD-ROM; a carrier wave received from the Internet; or other forms of computer-readable memory such as read-only memory (ROM) or random-access memo (RAM).

The processes of the invention can be implemented in a variety of ways using any number of programming languages such as HTML, PHP, Java, JavaScript, Active Server Pages, Visual Basic, C++ and the like, and can include other modules, programs, applications, scripts, processes, threads or code sections that interrelate with each other. The program modules can also be commercially available software tools.

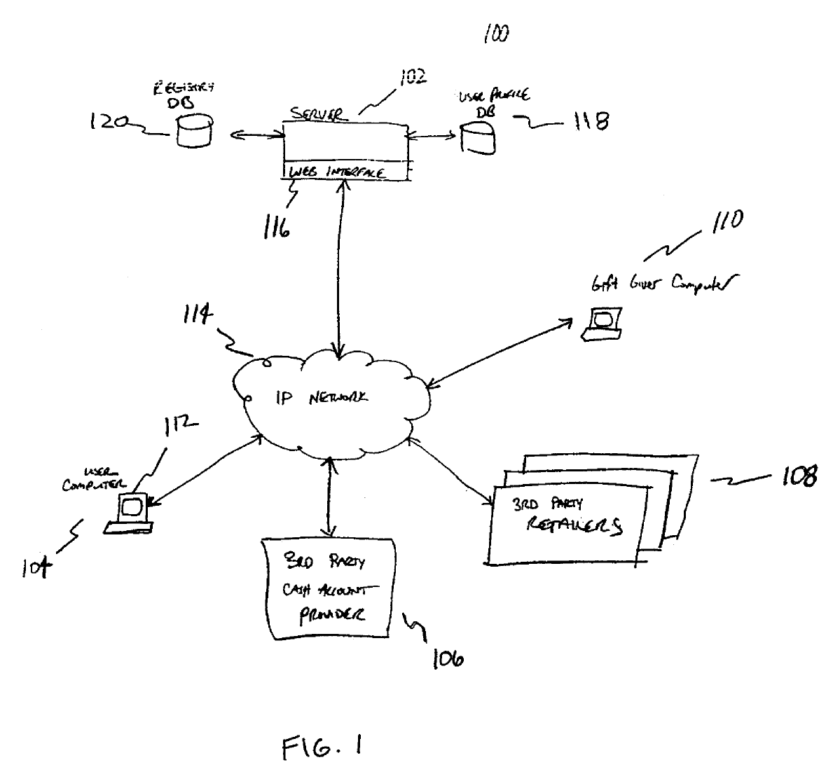

FIGS. 1, 2, and 3 are drawings depicting a schematic of the system architecture of an online gift registry with a cash gift feature 100 according to one aspect of the present invention.

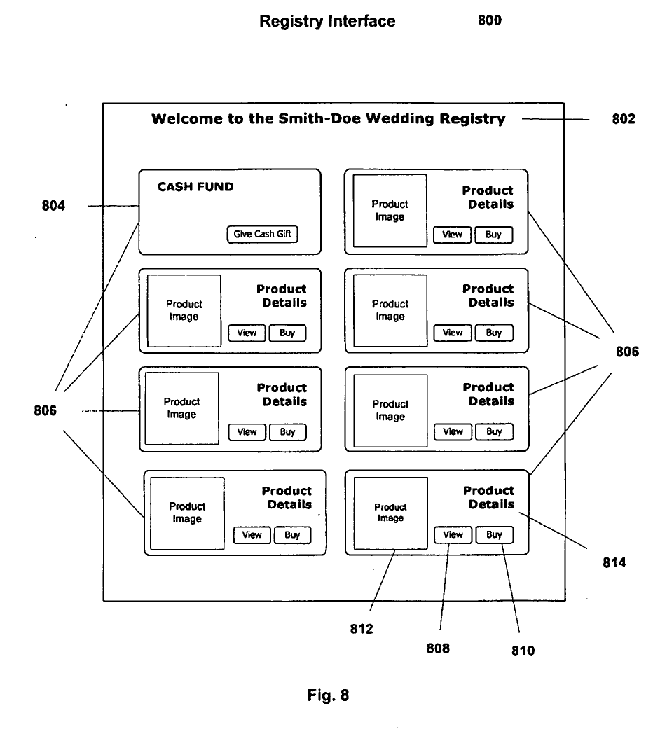

Turning first to FIG. 1, shown therein is a drawing depicting a schematic of the general system architecture of an online cash gift registry system 100 according to one aspect of the present invention. The system 100 includes a server subsystem 102, a gift registry registrant 104, a gift giver 110, a third party cash account provider 106, and third party retailers 108. The system 100 is designed to facilitate a financial transaction between the gift giver 110 who may be desirous of giving a cash gift 804 (as seen on FIG. 8), and the gift registry registrant 104 who may be desirous of receiving the cash gift 804.

Given the descriptions of the preferred and alternative embodiments of the present invention, it will be readily appreciated that the invention is not limited to any particular monetary denomination or world currency.

The invention contemplates that the gift registry registrant 104 will submit information to the server subsystem 102 for creating an online gift registry account, which will include a user profile. Submission of the information may be made using a personal computer 112 in data communication over a communications network 114 with a web server 116 in the server subsystem 102. Alternatively, or in conjunction with providing the information electronically, the gift registry registrant 104 may provide the information telephonically, through written submission, or some other means. The user profile information may be saved in a database 118.

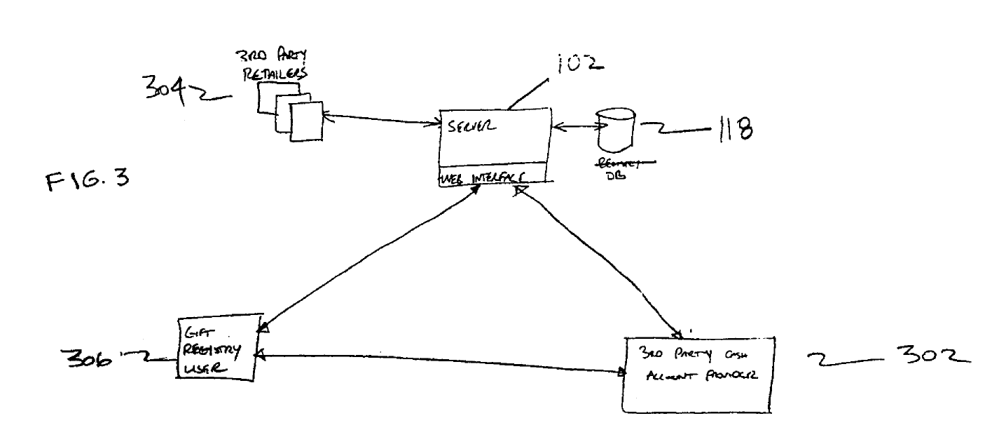

The gift registry registrant 104 may customize the online gift registry either at the time of establishing the registry, or at any later time. One of the customization features available to the gift registry registrant 104 is the option to populate the registry with products selected from the third party retailers 108, such as by identifying retail consumer goods that the gift registry registrant 104 would like to receive. The customized details of the gift registry may be saved in the same database as the user profile 118 as shown in FIG. 3, or in a separate registry database 120.

One of the other customization features presented to the gift registry registrant 104 is the creation a cash gift 804 option allowing gift givers 110 to give a cash gift 804 to the gift registry registrant 104 instead of purchasing one of a number of the selected products from the third party retailers 108 mentioned above. If the gift registry registrant 104 elects to activate the cash gift option, the gift registry registrant 104 is, in one embodiment of the invention, directed to a third party cash account provider 106 where the gift registry registrant 104 can create a new third party cash account. The third party cash account provider can be any financial institution that provides an account in which funds can be credited and debited. Online cash account providers such as PayPal™, BidPay^{SM}, and OboPay™, traditional credit card and debit card account providers, and savings and checking account providers, are examples of such third party cash account providers.

In an alternative embodiment, the gift registry system 100 itself may provide the cash account feature of the present invention. That is, the cash account may be created by the system 100 at the server 102 in response to an election by the gift registry registrant 104 electing to enable the cash gift option, rather than the gift registry registrant 104 being directed to a third-party website to set up a cash account, reloadable debit card account, or the like. As a result, the creation of the cash account, reloadable debit card account, or the like, and linking of the account to the online gift registry is all done at the server 102 and is transparent to the gift registry registrant 104, or is done completely in the background so that the gift registry registrant 104 does not see what is occurring. For example, if a service provider like BidPay^{SM} were used, a gift registry registrant 104 would enter his or her personal information needed to set up an account with the service provider, either directly at the service provider's website, or by entering the information using the system 100, in which case the system 100 would cause the server 102 to provide the necessary personal information directly to the service provider to set up the account so that the gift registry registrant 104 does not have to be involved with setting up the account (other than providing the required account setup information to the server 102). Also, it is contemplated that more than one cash account may be created, designated, indicated, or otherwise selected by the gift registry registrant 104, wherein one of the accounts is created by a third party and another is created by the system 100.

A gift giver 110 can access the online gift registry for a particular gift registry registrant 104 by accessing the web interface 116 of the online cash gift server 102. The gift giver 110 will identify the gift registry registrant 104 to whom he wishes to give a gift. The server 102 will retrieve the registry information from the registry database 120 in response to the identification of the gift registry registrant 104 by the gift giver 110. The gift giver 110 will be presented with a list of the selected products chosen by the gift registry registrant 104. The gift giver 110 can select any of the selected products to purchase on behalf of the gift registry registrant 104 as a gift. If the gift registry registrant 104 has elected to activate the cash gift feature, the gift giver 110 will also be presented with the option to gift cash to the gift registry registrant 104 or to contribute cash toward the purchase of a particular product on the list of products selected by the registrant 104. It is also contemplated that the gift giver 110 may be presented with a list of the cash accounts associated with the gift registry and may select to provide a cash gift to a particular cash account.

In one embodiment of the invention, the gift giver 110 is presented with a form at the web interface 116 for entering necessary information to process a credit card FFT transaction according to well known credit card transaction procedures, whereby the gift giver's 110 credit card account is debited a cash amount selected by the gift giver 110 and whereby the gift registry registrant's 104 account is credited with the same amount (or by a smaller amount after deducting a pre-determined transaction fee by the system 100). The gift giver's 110 end-of-cycle account statement could show, for example, a line entry such as “Cash Gift. Thank You. ‘http://www.myregistry.com’,” or the like (or simply a generic or non-descriptive line entry). The gift registry registrant's 104 account may be any account, as described above, held in the gift registry registrant's 104 name or by a third party. The account may be linked, as described previously, to a reloadable debit card or a traditional credit card, which may have previously been issued to the gift registry registrant 104 or which is issued to the gift registry registrant 104 after cash gifts 804 (see FIG. 8) are made by the gift giver 110.

Instead of using a credit card to initiate the transaction as described above, a third party may be used to handle the transaction, such as BidPay^{SM}, PayPal™, or the like. The gift giver 110 is presented with a form at the web interface 116 for entering necessary information to process a third party financial transaction according to well known transaction procedures of financial entities such as those noted above, whereby the gift giver's 110 third party account is debited a cash amount selected by the gift giver 110 and whereby the gift registry registrant's 104 account is credited with the same amount (or, as indicated previously, by a smaller amount after the system 100 deducts a pre-determined transaction fee). It will occur to persons skilled in the art that any combination of credit card account, financial institution account, third party cash account, or a cash account provided by the system 100 can be used to facilitate the cash transaction between the gift giver 110 and the gift registry registrant 104.

The server 102 may be any computerized system including one or more server computers that are adapted to, among other things, store and process data, protect data and access to the system using a firewall or some other security measure, generate responses to client device requests for markup language files and information, and provide access to user information.

The client computer may be any computerized system having one or more electronic client devices that are adapted to, among other things, process data, access the server 102, preferably via a web site graphical user interface that is generated on the electronic client devices using markup language commands and data provided to those devices by the server 102.

As shown in FIGS. 1-3, the server 102 is in data communications with the gift registry registrant 104 (also 206 and 306) through one or more data communications networks 114. The particular connectivity of the server 102 to the data communications networks is for illustrative purposes only. The networks may be, for example, a wireless network used by mobile computing devices like cellular telephones, the Internet, an intranet, or some other data communication system. Preferably, the networks are packet-switched networks capable of routing hypertext, extensible, or other types of markup language code and data in accordance with the standard Internet Protocol or some other protocol in order to generate web pages. The Internet Engineering Task Force is the standards body that creates and maintains the basic standards on which the Internet depends, including the Internet Protocol specification published in 1981.

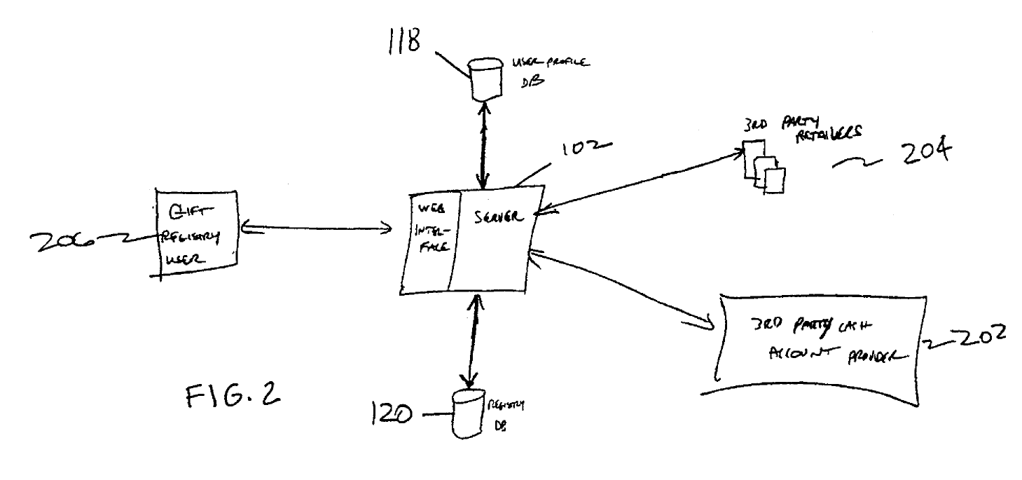

Turning now to FIG. 2, shown therein is another drawing depicting a schematic of the general system architecture of the online cash gift registry system 100 according to one aspect of the present invention. FIG. 2 depicts data communication with the third party cash account provider 202 and the third party retailers 204 such that the gift registry user's 206 interaction with the third party cash account provider and the third party retailers occurs through the server 102 instead of independent of the server 102 as shown in FIG. 1. In another embodiment of the present invention, the gift registry user may not interact any third party cash account provider, as when the cash account is provided by the system 100 itself rather than by a third party cash account provider.

In FIG. 3, which is another drawing depicting a schematic of the general system architecture of the online cash gift registry system 100 according to one aspect of the present invention, there is shown a hybrid data communication architecture in which the gift registry user's 306 interaction with the third party retailers 304 occurs through the server 102 while interaction with the third party cash account provider 302 occurs independent of the user's 306 interaction with the server 102.

Operation of the preferred embodiment of the system begins with a gift registry registrant 104 logging on to the website of an online gift registry service provider, such as MyRegistry.com®, and creating a personalized gift registry account. The gift registry registrant 104 may be, for example, an individual, a group of individuals (such as, but not limited to, an engaged couple, an entire family, employees at a company), or an entity (such as, but not limited to, a charitable organization, a not-for-profit center, or a for-profit corporation). Also, it is not required that the gift registry registrant 104 be the gift recipient, but for purposes of illustrating the present embodiment, the registrant and the gift recipient are one and the sane. That is, the gift recipient may be a beneficiary designed by the gift registry registrant 104 to receive gifts. Information about beneficiaries may be supplied by the gift registry registrant 104, as described below.

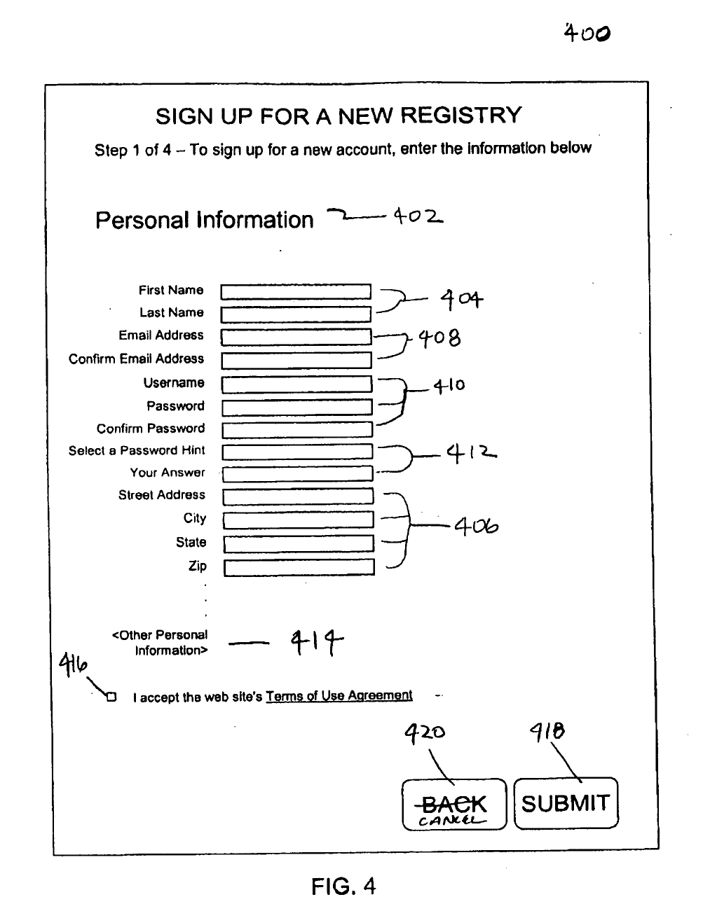

FIG. 4 is a drawing of an exemplary computer screen representation of an initial sign-up screen 400 according to one aspect of the present invention. One of ordinary skill in the art will appreciate that there are myriad ways in which a gift giver 110 can interface with the system 100 using one or more forms like the one shown in FIG. 4 (and in the following figures described below). The technique described here is but one such method.

The screen (images, text, links, etc.) is presented to the registrant when he chooses to create a new online gift registry account (an account is simply related or non-related electronic records associated with the gift registry registrant 104). The gift registry registrant 104 will enter personal information 402 including, but not limited to, name 404, address 406, email address 408, an account username and password 410, a password hint 412, and other personal information 414. The gift registry registrant 104 will also agree, in this example, to the website's terms of use agreement 416. The gift registry registrant 104 is presented with clickable buttons to electronically submit 418 his personal information to the server 102 or cancel the sign up process 420 (as noted above, some of the requested information may also be provided telephonically, by written submission, or other means).

Upon clicking the submit button 418, the gift registry registrant's 104 personal information 402 is transmitted over the communications network 114 from the registrant's personal computer 112 to the server subsystem 102 via the web server 116 interface where it can be stored to a user profile record in database 118.

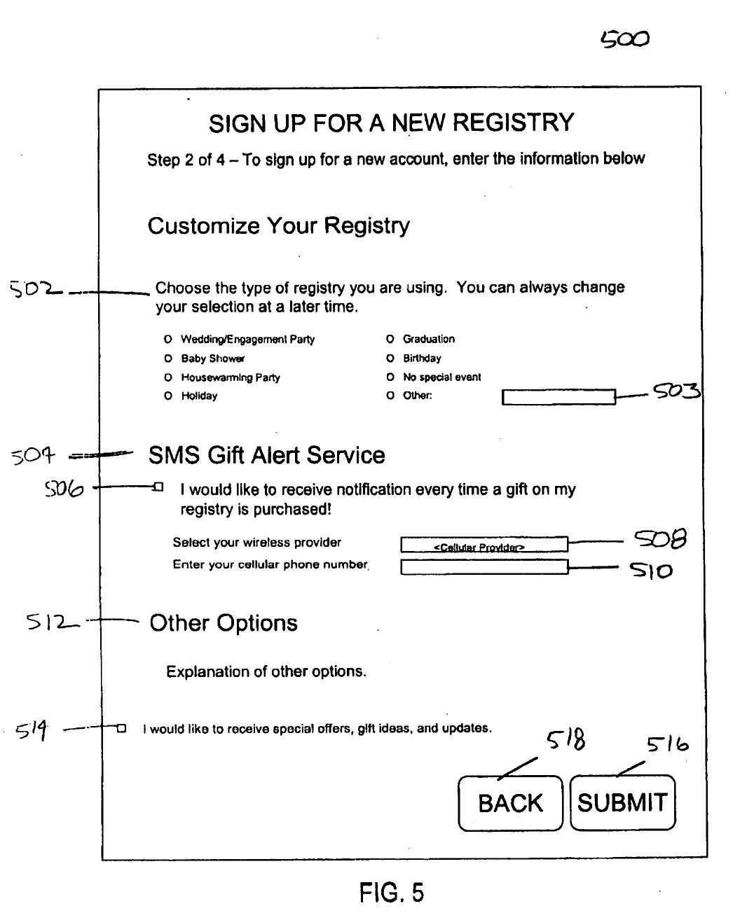

The gift registry registrant 104 is then presented with the next screen 500 in the sign up process as shown in FIG. 5. The gift registry registrant 104 may input selections to customize the online gift registry account that is to be created. For example, in this embodiment of the present invention, the registrant may select a type of registry 502 such as wedding registry, baby shower registry, a birthday registry, a combination of those registries, among others, or may assign a custom registry type using a text box to input the title 503.

The gift registry registrant 104 may also elect to receive notification of activity 504 in the registry account on a cellular phone via an SMS message or other suitable format of electronic notification (written notification through the traditional mail is also contemplated). The gift registry registrant 104 can enable this feature by, for example, checking the check box 506, entering a cellular phone service provider 508, and entering a cellular phone number 510.

There may also be other customization features 512 available to the gift registry registrant 104 at this step of the sign up process, such as electing to receive special offers or updates from the gift registry service provider or interested third parties 514. The gift registry registrant 104 is presented with clickable buttons to submit 516 the customization information to the server 102 or to go back 518 to the previous step 400.

Upon clicking the submit button 516, the gift registry registrant's 104 customization information is transmitted from the registrant's personal computer 112 to the server subsystem 102 via the web server 116 interface where it can be stored to one or more databases 118, 120.

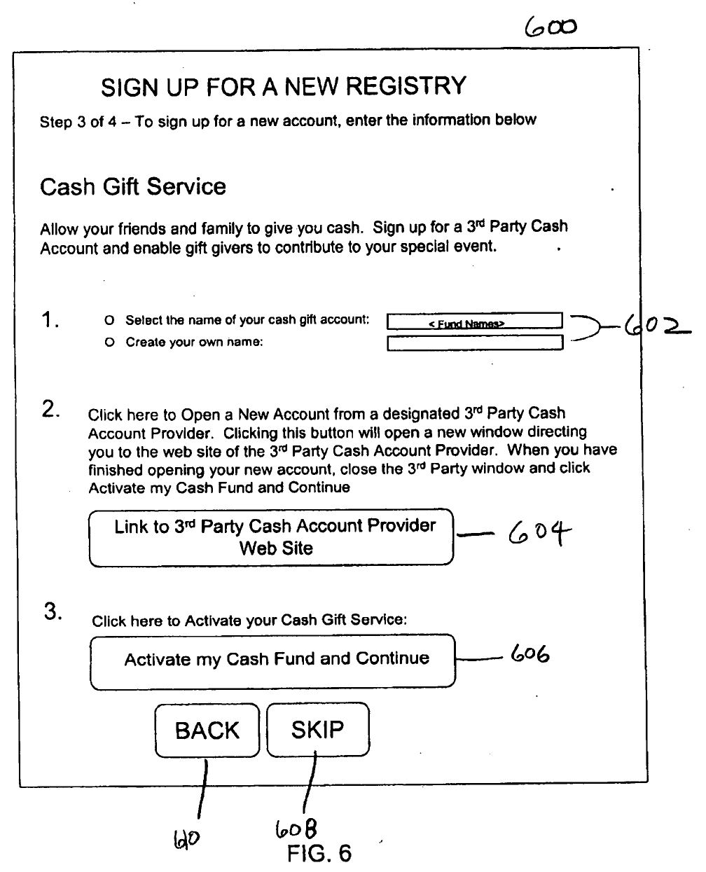

The gift registry registrant 104 is presented with the next screen 600 in the sign up process as shown in FIG. 6, which illustrates a preferred, but not the only way of providing for interacting with the system 100. In this step, the gift registry registrant 104 can elect to sign up for a cash gift service to allow gift givers 110 to give a cash gift 804 in lieu of purchasing a product on behalf of the gift registry registrant 104. The gift registry registrant 104 enables this feature by selecting a name for the cash gift account 602.

In one embodiment of the invention, the gift registry registrant 104 would then click on a button 604 linking to an exclusive third party cash account provider 106. In an alternative embodiment, the gift registry registrant 104 may be able to select from several third party cash account providers of various apes such as PayPal™, BidPay^{SM}, OboPay^{SM}, a credit card provider, or bank account provider, among others. Basically, any type of financial transaction organization or service provider is contemplated for purposes of this invention, which is not limited to any specific type of electronic fund transfer technique used, or method of debiting and crediting financial accounts associated with customers of financial organizations. Moreover, the system 100 is designed, in one respect, to make portions of, or the entire process of, transferring cash to cash accounts either transparent to the gift registry registrant 104 (where the gift registry registrant 104 is involved in all or some of the steps for transferring cash gifts to his or her cash account), or it is done partially or completely in the background by the server 102 so that the gift registry registrant's 104 involvement is viewed by the gift registry registrant 104 as being minimized (this would be done, for example, to allow the gift registry registrant 104 to focus on other aspects of their gift registry).

In an alternative embodiment, the gift registry registrant 104 would create a cash account at the server 102 of the system 100, rather than linking to a third party cash account provider 106. In this embodiment, the financial transaction of giving a cash gift would be handled at the server 102 without participation by a third party cash account provider 106.

The button 604 takes the gift registry registrant 104 to the website of the third party cash account provider 106 where the gift registry registrant 104 can create a new account, which also generates a referral fee for the referring online gift registry service provider. Upon creating the third party cash account at the website of the third party cash account provider 106, the gift registry registrant 104 can return to 600 and click a button 606 to activate his cash gift account. The gift registry registrant 104 is also presented with buttons to skip 608 the cash gift account feature setup or to go back 610 to the previous step 500.

In other embodiments of the present invention, the cash account may be created and hosted or maintained by the online gift registry service provider instead of by a third party cash account provider 106.

Upon clicking the activate button 606, the gift registry registrant's 104 cash gift account information is transmitted from the registrant's personal computer 112 to the server subsystem 102 via the web server 116 interface where it can be stored to a database 118, 120.

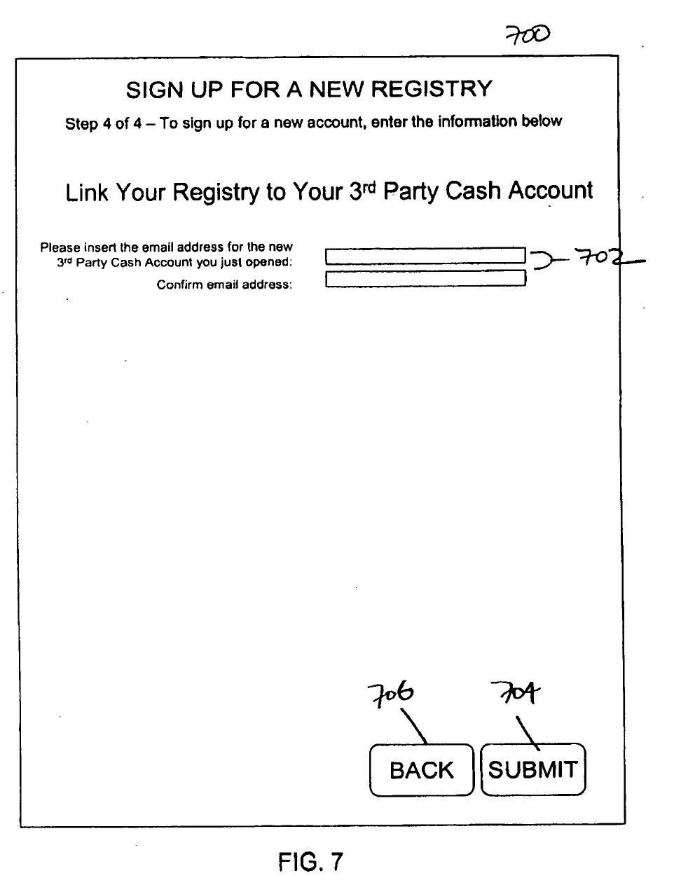

The gift registry registrant 104 is presented with the next screen 700 in the sign up process as shown in FIG. 7. In this step, the gift registry registrant 104 can link the third party cash account created at the website of the third party cash account provider 106 with the online gift registry service provider. The gift registry registrant 104 inputs the email address 702 used to sign up for the third party cash account (needed by some third party financial service providers, such as PayPal^{SM}; others may not need an email address), and then submits the information to the server subsystem 102. In this way, the online gift registry service provider can collect a referral fee from the third party cash account provider by showing that creation of the new third par cash account associated with the particular email originated from the online gift registry provider. The amount of the referral fee would be specified in the preexisting contractual agreement between the online gift registry service provider and the third par cash account provider (other fee arrangements between the gift registry system 100 and third parts account providers is also contemplated).

The gift registry registrant 104 is presented with buttons to submit 704 the account linking information to the server subsystem 102 or to go back 706 to the previous step 600. Upon clicking the submit button 704, the account setup process is complete. The gift registry registrant 104 may then follow instructions to add products to the gift registry from the third par retailers 108.

In an alternative embodiment of the present invention, the process of creating a third party or provider-based cash gift account and linking the cash gift account to the online gift registry does not occur during gift registry setup. Instead, during setup, the gift registry registrant 104 elects only to sign up for a cash gift service to allow gift givers 110 to give a cash gift 804 in lieu of purchasing a product on behalf of the gift registry registrant 104. The gift registry registrant 104 enables this feature by selecting a name for the cash gift account 602, as shown in FIG. 6. At this point, setup of the cash gift service in the gift registry is complete. Later, when a gift giver elects to make a cash gift, an email is sent to the gift registry registrant 104 informing him or her that a cash gift has been received. In one embodiment, the email provides a link and instructions to the gift registry registrant for setting up the third party or provider-based cash gift account for purposes of retrieving the cash gift received. Once the cash gift account has been activated and linked to the cash gift service, the provider can credit the cash gift account with the cash amount gifted by the gift giver. The gift registry registrant will then have access to the cash. By deferring the cash gift account setup until after a cash gift has been received, the initial setup process is streamlined.

Turning now to FIG. 8, which is another drawing of an exemplary computer screen representation of one aspect of the present invention, shown therein is a gift list interface 800 presented to a gift giver 110 upon visiting the online gift registry service provider website and accessing the gift registry account for a particular gift registry registrant 104. The interface 800 displays the title 802 of the registry to the gift giver 110. If the gift registry registrant 104 has enabled the cash gift service option, the gift giver 110 is presented with a menu item for giving a cash gift 804. The third party retailer 108 products desired 806 as identified by the registrant 104 are also displayed to the gift giver 110. Each product listing may be accompanied by a picture 812 of the product and a brief description of the product 806. In addition, the gift giver 110 may click on a particular product link 808 to view more information about the product 806. Each product 806 can be purchased by the gift giver 110 by clicking on a “buy product” link 810.

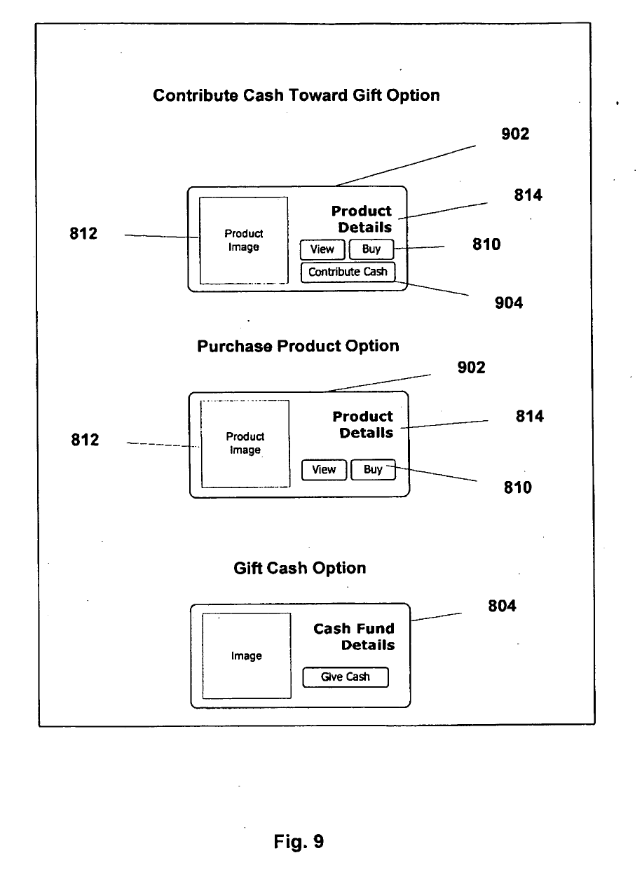

As shown in FIG. 9, which is another drawing of an exemplary computer screen representation of an interface module of one aspect of the present invention, the gift giver 110 has the option of contributing a desired amount of cash toward the purchase of a particular product. This is useful when a particular item is too expensive for one gift giver to purchase, such as a car, a trip, or a home theater system, but several gift givers making individual contributions can together contribute the necessary funds. Thus, the gift giver 110 is presented with a button to contribute cash 904 in product listing 902. When the gift giver 110 clicks on the contribute cash option, he can input the amount of cash he wishes to contribute toward the particular product 806. When the sufficient funds have been collected to purchase the expensive item, the gift recipient will be notified and can log on to the online gift registry account to complete the purchase.

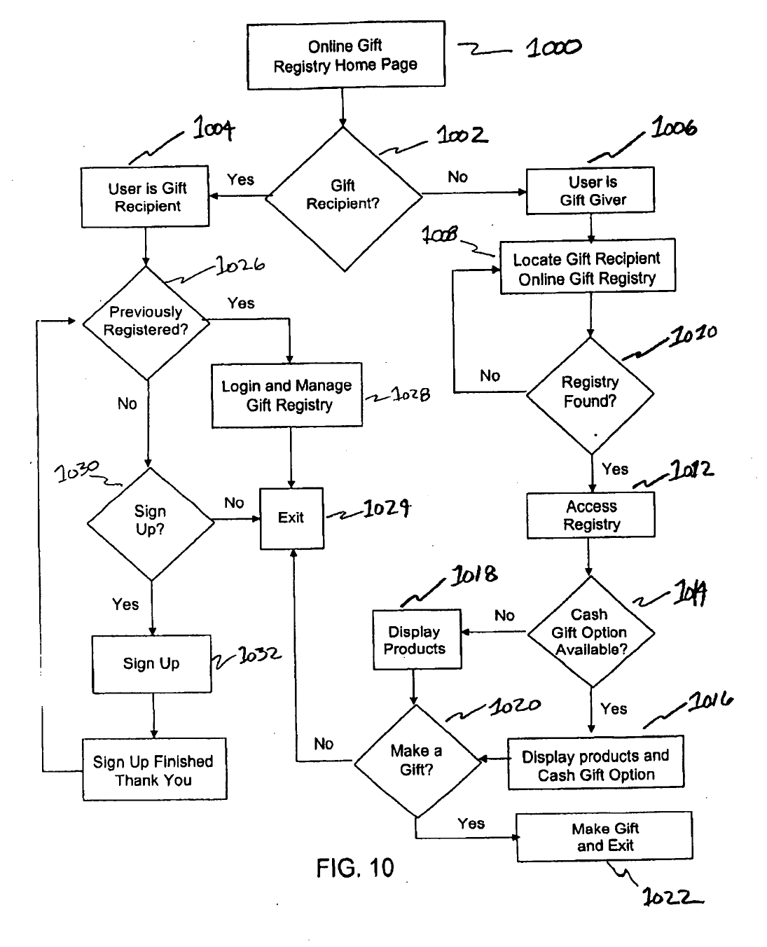

The above general description of the system interface is now explained in more detailed by reference to the several process flow diagrams, beginning with FIG. 10, which is a process flow diagram depicting the online gift registry service provider website process flow steps according to an embodiment of the present invention. In process step 1000, the website user interfaces with the system 100 by visiting a website preferably through a networked personal computer 112 via the server subsystem 102 web server 116. The networked personal computer 112 interfaces with the server subsystem 102 web server 116 via a data communications network 114 and receives HTML pages (or other pages generated using HTML or a combination of extensible markup languages and well known web applications).

In process step 1002, if the user is a gift registry registrant 104, the user is directed to the gift registrant functionality of the website as shown in process step 1004. If the user is not a gift registry registrant 104, he is determined to be a gift giver 110 and is directed to the gift giver functionality of the website 1006.

In process step 1008, the gift giver 110 will locate the online gift registry of a particular gift registry registrant 104.

In process step 1010, if the correct online gift registry is not found, the gift giver is directed back to process step 1008.

If the correct online gift registry is found, the gift giver 110 can view the registry as shown in process step 1012.

In process step 1014, if the gift recipient has enabled the cash gift feature, the gift giver is directed to process step 1016 where the gift giver 110 can view the products selected for purchase on behalf of the gift registry registrant 104 and the cash gift features as described above.

In process step 1018, the gift giver 110 can view the products selected for purchase on behalf of the gift registry registrant 104.

In process step 1020, if the gift giver 110 elects to make a gift, he is directed to the gifting functionality of the website as shown in process step 1022. If the gift giver 110 elects not to make a gift, he may exit the system 1024.

As described in process step 1026, if the gift registry registrant 104 has previously registered for an online gift registry, he is directed to the account management functionality of the website as shown in process step 1028. If the gift registry registrant 104 has not previously registered for an online gift registry, he is given the opportunity to do so as shown in process step 1030. If the gift registry registrant 104 elects not to sign up for an online gift registry, he may exit the system as shown in process step 1024. If the gift registry registrant 104 elects sign up for an online gift registry, he is directed to the account sign up functionality 1032 of the website as described in FIGS. 4, 5, 6, 7, and 12. After signing up, the user may access the system as a registered user.

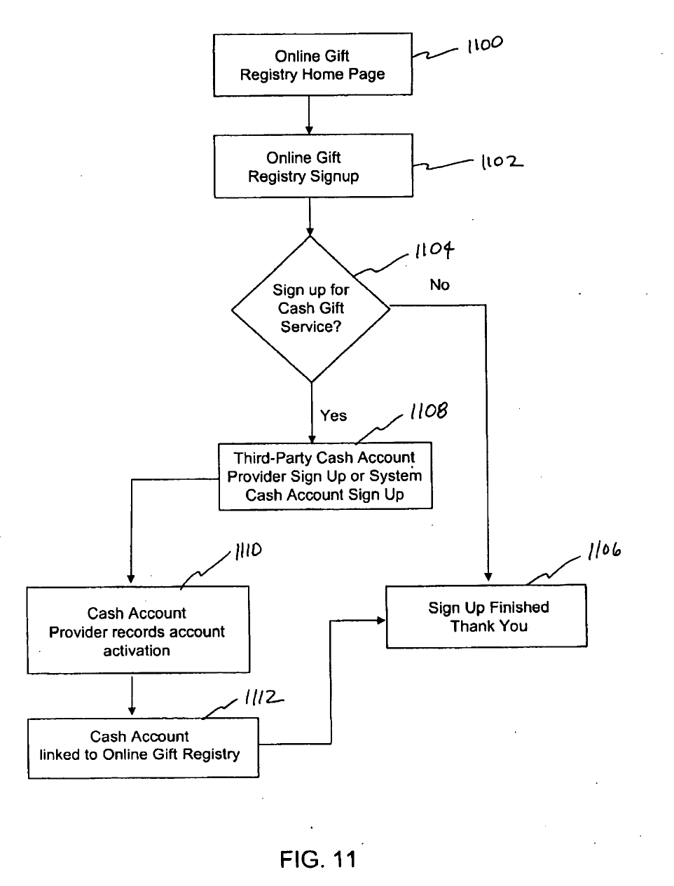

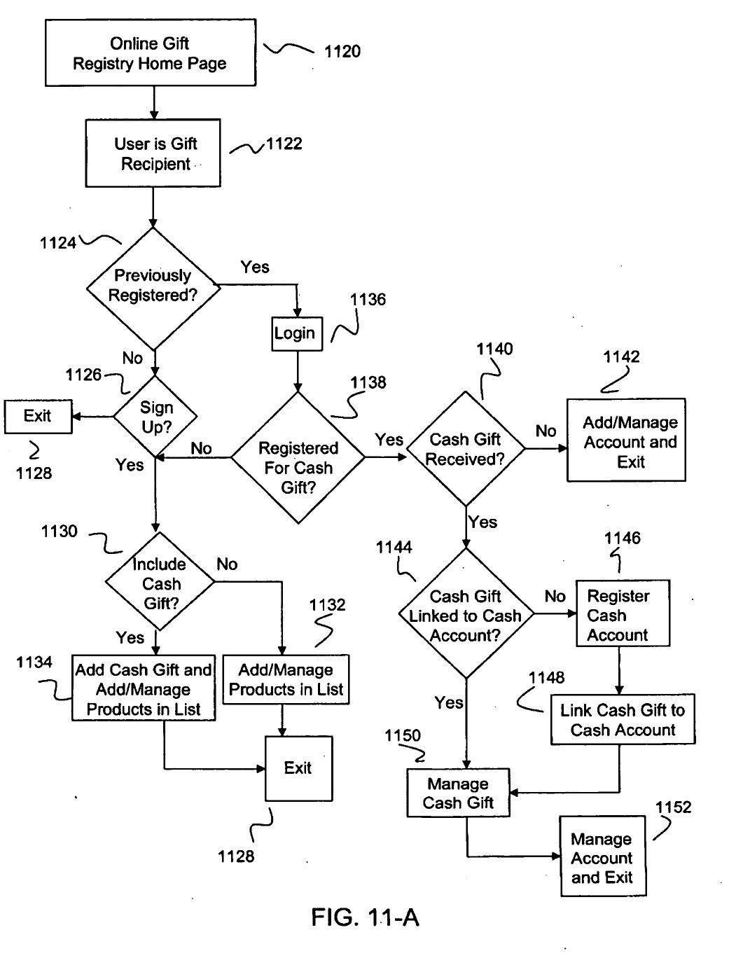

Turning now to FIG. 11, shown therein is a process flow chart depicting the general process of signing up for an online gift registry including the option to register for the cash gift service 1100. From the Online Gift Registry Home Page, the gift recipient may proceed to online gift registry sign up in which he is asked to enter his personal information as shown in process step 1102.

In process step 1104, if the registrant 104, does not elect to sign up for the cash gift service, he is directed to the sign up finished step 1106.

If the gift registry registrant 104 elects to activate the cash gift service, he is, in a preferred embodiment, directed to a third party cash account provider, as described previously, to sign up for a cash account as described in process step 1108. The third-party website may appear outside the online gift registry website or may be integrated therein. The third party cash account provider then records confirmation that the gift registry registrant's 104 account has been set up with an identifying code (not shown) to that particular recipient as described in process step 1110. The registrant 104 then activates their cash gift service account by linking the cash account and the online gift registry account 1112. Upon successfully signing up for the third-party cash account, the user is directed to the Sign Up Finished—Thank You stage as shown in process step 1106. In alternative embodiment, the cash account may be provided by the online gift registry system 100 rather than by a third-party cash account provider. In that embodiment, the gift registry registrant 104 would not be directed to a third-party website to sign up for a cash account. Instead, creation of the cash account would occur at the server 102.

An alternative embodiment of the present invention is shown in FIGS. 11-A and 11-B wherein signup for a third-party or provider-based cash gift account is addressed only after the gift registry registrant 104 has actually received a cash gift. Turning now to FIG. 11-A, shown therein is a process flow diagram depicting the online gift registry sign up process flow diagram according to this embodiment of the present invention. In process step 1120, a user accesses the online gift registry home page. In process step 1122, the user is determined to be a gift registry registrant 104. In process step 1124, if the gift registry registrant has not previously registered a gift registry account, the gift registry registrant 104 is prompted to register 1126. If the user does not wish to sign up for an online gift registry, the user may exit the system 1128. If the user chooses to register, the user is prompted as to, among other things, whether the user wants to include a cash gift option on the online gift registry 1130. If the gift registry registrant 104 does not wish to include a cash gift option on the online gift registry, the registrant 104 can add products for purchase by gift givers to the newly created online gift registry 1132 and then exit the system 1128. If the registrant 104 wants to include a cash gift option on the online gift registry, the registrant 104 can add products for purchase by gift givers to the newly created online gift registry and the online gift registry will include a cash gift option 1134 and then exit the system 1128.

If, at process step 1124, the user has previously registered an online gift registry, the user is prompted to enter his or her login information 1136. If the user has not previously registered for a cash gift option in the online gift registry 1138, the registrant 104 is given the option to sign up 1126. If the registrant 104 has previously signed up for a cash gift option but a cash gift has not yet been received 1140, the registrant can manage their account and exit the system as normal 1142. If a cash account has been received 1140 and the registrant 104 has not previously created and/or linked a cash gift account to their cash gift fund 1144, the registrant is given the opportunity to do so. In process steps 1146 and 1148, the registrant 104 may establish a third-party or provider-based cash account as described in FIG. 11 and link the cash account to the cash gift option of the online gift registry. The system will credit the linked cash gift account with the cash gift amounts received thus far and that cash gift amount will become available to the registrant 104 as previously described 1150.

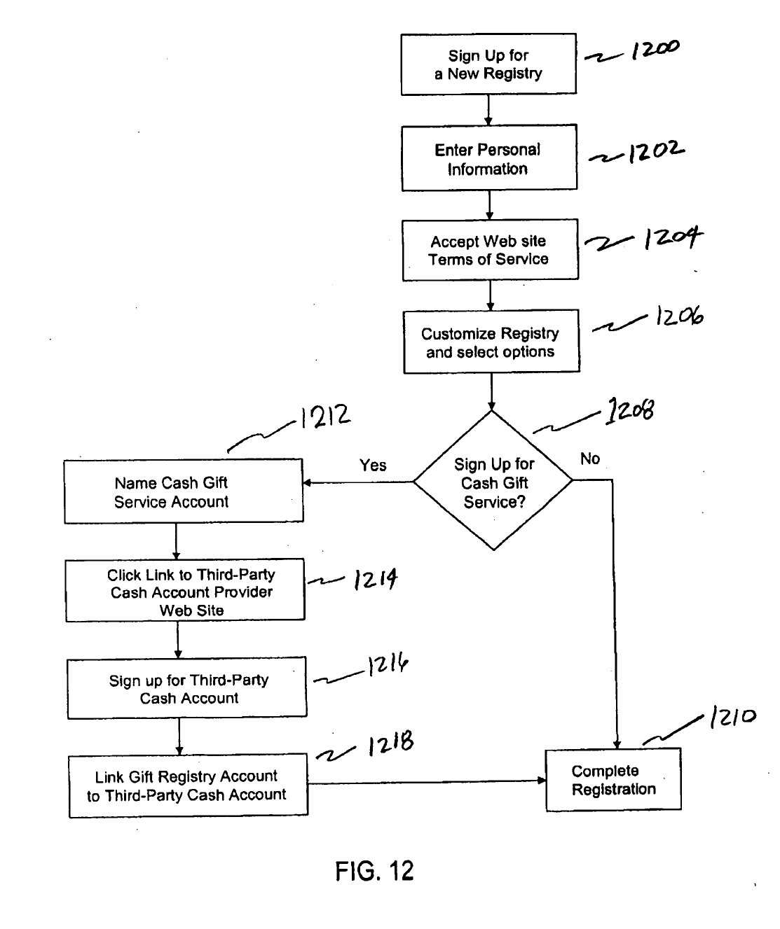

Turning now to FIG. 12, shown therein is a process flow diagram depicting the online gift registry sign up process flow steps according to an embodiment of the present invention. In process step 1200, the gift registry registrant 104 elects to sign up for a new online gift registry by providing requested information to the server subsystem 102.

In process step 1202, the gift registry registrant 104 is prompted to enter personal information such as name 404, address 406, email address 408, an account username and password 410, a password hint 412, and other personal information 414 as described in FIG. 4.

In process step 1204, the gift registry registrant 104 is prompted to accept the terms of service of the website 416 before proceeding. In process step 1206, the registrant 104 can customize the features and functions of his online gift registry as described in FIG. 5.

In process step 1208, if the gift registry registrant 104 does not elect to enable the cash gift service, he is directed to complete registration as shown in process step 1210. If the gift registry registrant 104 does elect to enable the cash gift service, he is directed to the cash gift service activation functionality of the website.

As described in FIG. 6, in process step 1212, the gift registry registrant 104 may name the cash gift account.

In process step 1214, the gift registry registrant 104 may click a link to a third party cash account provider website.

In process step 1216, the gift registry registrant 104 signs up for a third party cash account.

In process step 1218, the registrant 104 links the online gift registry account to the third pare cash account as described in FIG. 7.

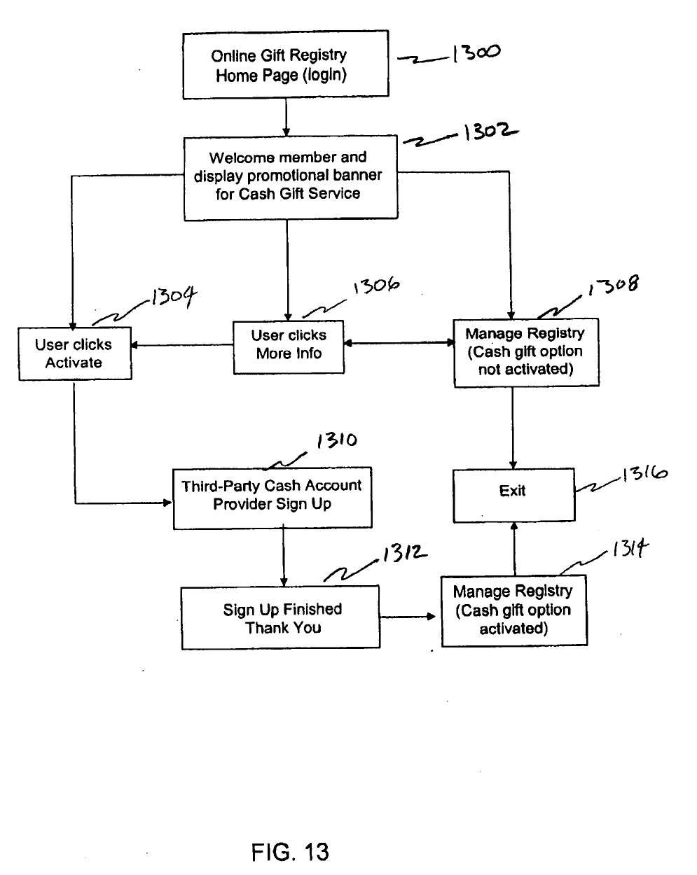

As shown in FIG. 13, which is a process flow chart depicting the process of registering for the cash gift service if a gift registry registrant 104 previously signed up for the online gift registry without signing up for the cash gift service, upon logging in to online gift registry service provider web site as shown in process step 1300, the gift registry registrant 104 is presented with a promotional banner describing the cash gift service as shown in process step 1302. The banner provides links to allow the gift registry registrant 104 to activate the cash gift service as shown in process step 1304 or receive more information about the service as shown in process step 1306.

The gift registry registrant 104 may also manage his online gift registry without activating the cash gift service as shown in process step 1308. If the gift registry registrant 104 elects to manage his online gift registry without activating the cash gift service, he may still be presented with links to receive more information about the cash gift service 1306 and activate the cash gift service 1304 at a later time.

If the gift registry registrant 104 chooses to activate the cash gift service, he is directed to the third-party cash account provider 106 sign up process as previously described and as shown in process step 1310. Upon successfully completing sign up of the third party cash account, the user will be taken to a thank you screen 1312. In process step 1314, the user may manage his online gift registry account. In process step 1316, the user exits the system 100. Alternatively, as also previously described, the cash account setup process may be initiated in the background at the server 102, whereby the gift registry registrant 104 enters information that the system 100 uses to establish a cash account at a third pare service provider on behalf of the gift registry registrant 104 (that way, the gift registry registrant 104 only has to enter information personal information once).

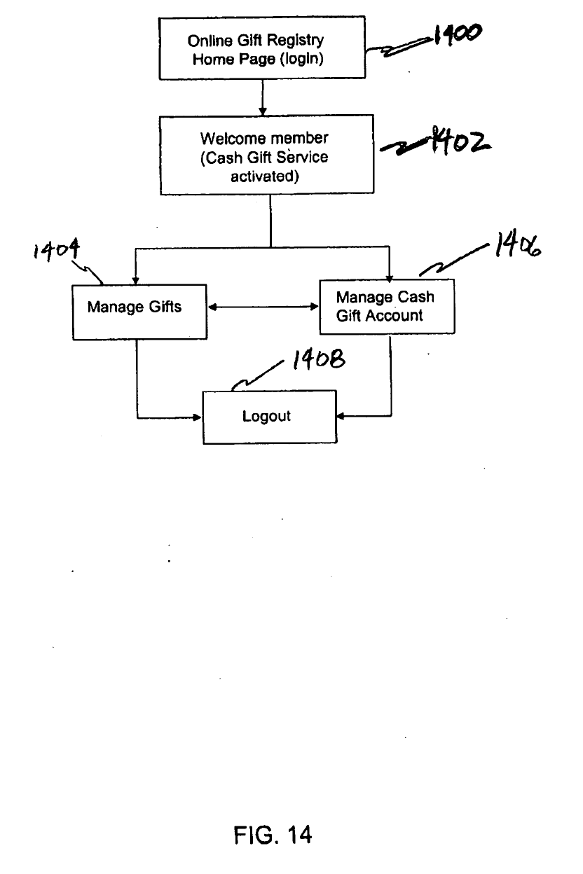

Turning now to FIG. 14, shown therein is a process flow chart depicting an exemplary process for managing an online gift registry service for a gift registry registrant 104 that has previously registered for the cash gift service. In process step 1400, upon login to the online gift registry service provider website, the gift registry registrant 104 may be greeted with a welcome banner as shown in process step 1402. The gift registry registrant 104 is permitted to manage the gifts activated in the registry by, for example, deleting selected gifts or adding new ones, as shown in process step 1404. In process step 1406, the user is also permitted to edit the settings of the cash gift service. In process step 1408, the user can log off of the website.

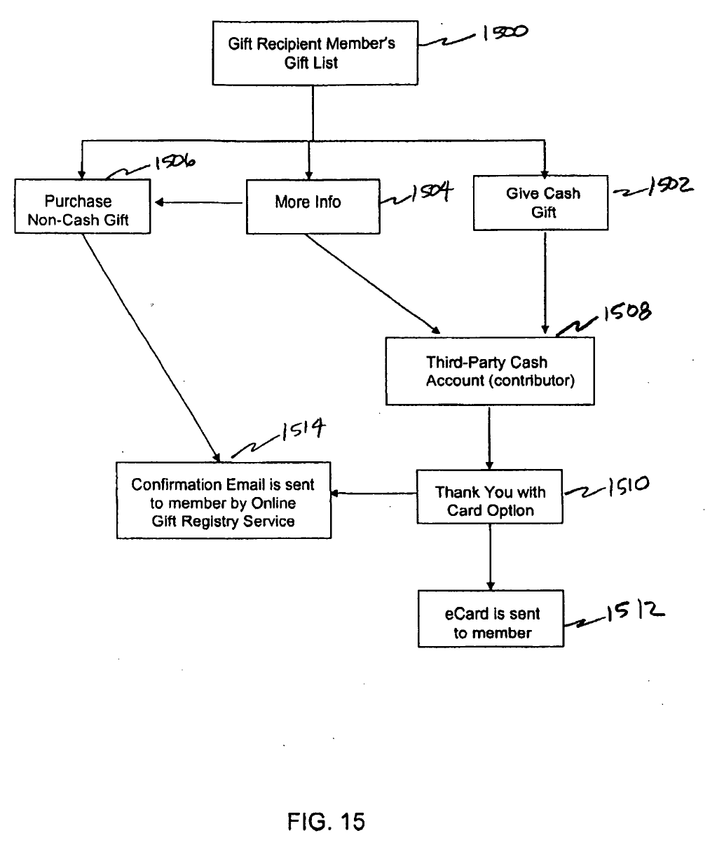

Turning now to FIG. 15, shown therein is a process flow chart depicting an exemplary process for a gift giver 110 making a cash gift 804 to the gift registry registrant 104 using the cash gift service in the gift registry registrant's 104 online gift registry. In process step 1500, the gift giver 110 visits the gift registry registrant's 104 gift list at the online gift registry service provider website. The gift giver 110 is presented with the option of making a cash gift 804 as shown in process step 1502, receiving more information about making a cash gift 804 as shown in 1504, or selecting a gift from the recipients designated gift list 1506.

If the gift giver 110 elects to make a cash gift 804, he is directed to the third-party cash account website as shown in process step 1508. The third party cash account website may appear outside the online gift registry website or may be integrated therein. The third party cash account website presents the gift giver with a series of steps as previously described that result in a cash gift 804 being deposited by credit card or other payment form into the gift recipient's account.

In process step 1510, the gift giver 110 is taken to a Thank You screen and an optional Thank You card can be automatically generated by the system for sending to the gift giver 110 on behalf of the gift registry registrant 104. In process step 1512, an electronic Thank You card, or eCard, is sent to the gift giver 110 if the option is enabled. A confirmation email or message may also be sent to the gift registry registrant 104 to alert him to activity in his online gift registry account as shown in process step 1514.

A preferred method of managing cash gifts 804 from a gift giver 110 to a gift registry registrant 104 is to transact a credit card purchase on behalf of the gift giver 110, as described above. Essentially what happens is that the system 100 can initiate a transaction to debit the gift giver's 110 credit card account for the amount of the cash gift 804. An Automatic Clearing House (ACH) transaction can then be originated by the system 100 using the third party cash account provider's routing number (RTN) and the gift registry registrant's 104 established account number associated with the third party cash account (or using the gift registry registrant's 104 personal bank account, a reloadable debit card account, a separate beneficiary account, or the like). Or, a third party financial service provider may perform all or some of those functions so that the gift giver's 100 cash gift is automatically routed to the gift registry registrant's 104 account.

In fact, the cash gift 804 may be contributed to more than one third party cash account set up by the gift registry registrant 104. For instance, if the gift registry registrant 104 includes a family of four individuals, each individual may set up their own third party cash account, or designate an existing account (e.g., bank savings account, charitable donation) to receive a fraction of the cash gift 804 made by the gift giver 110, the fraction being pre-determined by the individuals and stored as a record in the gift registry registrant's 104 online gift registry account. Instead of a fractional designation, the distribution scheme may, for example, be one in which a fixed amount of the cash gift 804 goes to one third-party account and the remainder is split three ways among the other three accounts. Or, the distribution scheme may designate that the cash gift 804 is routed to a specific third-party account based on the gift giver's 110 entered personal information (e.g., a cash gift 804 from a friend of one of the gift registry registrants 104 will be transferred to that gift registry registrant's 104 specific third-party account). There are many different schemes for transferring cash gifts 804 from a gift giver 110 to a gift registry registrant 104 in the case where the gift registry registrant 104 involves more than one individual.

In another embodiment of the present invention, the cash gift 804 can be collected by the online gift registry service provider instead of by a third party cash account provider (or multiple third-party providers). In that embodiment, the online gift registry service provider acts as a financial middleman or clearinghouse for receiving, accounting, and distributing cash gift 804 transactions.

In such an embodiment, the gift registry registrant 104 may also forgo the creation of a dedicated cash account, either by a third pare cash account provider or by the system 100, and instead choose to have the system 100 retain cash gifts made by gift givers 110 until such time as the gift recipient requests the system 100 to send the cash funds as, for example, a wire transfer to a preexisting financial institution account, such as a savings account or a reloadable debit card account.

Although certain presently preferred embodiments of the disclosed invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

I claim:

1. A computerized method for coordinating a financial transaction between a gift giver and a gift registry registrant at an online gift registry comprising the steps of
receiving, at a first server over a communications network, a set of registry account information about a gift registry registrant;
receiving a selection of items to be associated with the online gift registry account, wherein each of the items is selectable for purchase and wherein one of the items is cash;
outputting a first instruction to display the selection of items on one or more client computers; and
receiving a request to process a cash gift amount;
initiating a communication to the gift registry registrant that a cash gift amount has been received;
receiving in response to the communication an instruction for depositing cash in at least one cash account;
associating the online gift registry account with the at least one cash account.

2. The method according to claim 1, further comprising the step of crediting the cash gift from the gift giver to the cash account associated with the online gift registry of one of the plurality of registrants.

3. The method according to claim 1, wherein the cash gift is applied toward the purchase of an item in the selection of items.

4. The method according to claim 1, further comprising the step of storing the set of gift registry account information in a first storage medium.

5. The method according to claim 1, wherein the step of associating the cash account of the registrant with the online gift registry account of the registrant includes outputting an invoice to a cash account provider for receiving a referral fee.

6. The method according to claim 1, where the online gift registry registrant and the gift recipient are the same person.

7. A computerized method for coordinating a financial transaction between a gift giver and a gift registry registrant at an online gift registry comprising the steps of
receiving, at a first server over a communications network, a set of registry account information about a gift registry registrant, wherein at least a part of the set of registry account information includes an instruction for receiving a cash gift;
receiving a selection of items to be associated with the online gift registry account, wherein each of the items is selectable for purchase and wherein one of the items is cash;
outputting a first instruction to display the selection of items on one or more client computers;
receiving a request to process a cash gift amount;
initiating a communication to the gift registry registrant that a cash gift amount has been received;
receiving in response to the communication instructions for associating the online gift registry account with a cash account provided by a cash account provider;
initiating a financial transaction to electronically transfer the cash gift amount to the cash account; and
outputting a second instruction to display information about the transfer.

8. The method according to claim 7, further comprising the step of creating the cash account at the first server.
